(19) United States
(12) Patent Application Publication
(10) Pub. No.: US 2025/0245849 A1
(43) Pub. Date: Jul. 31, 2025

(54) METHOD FOR DETERMINING A VIEW OF A 3D POINT CLOUD

(71) Applicant: Telefonaktiebolaget LM Ericsson (publ), Stockholm (SE)

(72) Inventors: Volodya GRANCHAROV, Solna (SE); Sigurdur SVERRISSON, Kungsängen (SE)

(21) Appl. No.: 18/855,452

(22) PCT Filed: Apr. 27, 2022
(86) PCT No.: PCT/EP2022/061239

§ 371 Date: Oct. 9, 2024

(51) Int. Cl. G06T 7/70; G06T 15/20

(52) U.S. Cl. CPC G06T 7/70; G06T 15/20; G06T 2207/10028; G06T 2210/56

(57) ABSTRACT

A method is disclosed for determining a view of a three-dimensional, 3D, point cloud for display on a two-dimensional, 2D, screen. The method is performed by a computing device. The method includes obtaining the 3D point cloud. If a normal vector is available for each point of the 3D point cloud, the method includes determining the view based on directions of normal vectors for points of the 3D point cloud. Otherwise the method includes estimating a normal vector for each point of the 3D point cloud; and determining the view based on estimated normal vectors with symmetrical directions.

### TECHNICAL FIELD

The present disclosure pertains to the field of computer vision. More particularly, the present disclosure pertains to a computing device and a method for determining a view of a three-dimensional, (3D) point cloud for display on a two-dimensional (2D) screen.

### BACKGROUND

A three-dimensional (3D) point cloud can capture spatial relations between various objects and their dimensions in a physical environment. 3D point clouds are becoming an important part of many industrial and end-user applications such as 3D modeling, automatic driving, quality inspection, and the like. A 3D point cloud is a collection of points on external surfaces of an object in a 3D space. Each point is associated with X, Y, and Z coordinates, and may also be associated with features such as per-point color and normal vectors. For example, a point m represented as (Xₘ, Yₘ, Zₘ) can, e.g., be associated with a color feature (Rₘ, Gₘ, Bₘ) and/or a normal vector (Nₘ^{X}, Nₘ^{Y}, Nₘ^{Z}). A normal vector may also be referred to as a normal. The normal vector to a surface at point m is a vector perpendicular to the tangent plane of the surface at point m.

A user may need to visually inspect a 3D point cloud, and to perform measurements in a scene captured by the 3D point cloud. This can be done by software tools such as point cloud viewers that render 3D point clouds for display on a two-dimensional (2D) screen. There are free point cloud viewer tools like Potree or CloudCompare, and commercial solutions like Leica point cloud viewer. All these point cloud viewers can read multiple point cloud formats, e.g., LAS, PLY, XYZ, E57, etc., and then parse and render 3D point clouds for display.

When a collection of points in a 3D space is visualized on a 2D screen, a view needs to be selected. The term “view” includes, without limitation, a viewport representing points that are visible on a 2D screen. A user can observe a 3D point cloud by these visible points.

Many point cloud viewers by default select an object-centered perspective mode, where the view allows a rendered 3D point cloud to be placed in a central area of a screen. FIG. 1 illustrates an example of two different views of an indoor scan for an office building. An indoor scan may also be referred to as an interior scan since an image scanning device is placed within an object to be scanned. FIG. 1a illustrates an object-centered perspective mode of a 3D point cloud where a rendered point cloud is nicely entirely visualized. However, since the indoor scan is performed inside the office building and all essential details are hidden inside the rendered point cloud, the outside view of the point cloud does not bring useful information to the user. In the present disclosure, the term “object-centered perspective mode” may also be referred to as an exterior view.

FIG. 1b illustrates a viewer-based perspective mode of the same 3D point cloud as in FIG. 1a. In FIG. 1b, details inside the office building are shown. For this particular scan, FIG. 1b is a suitable view of the office building since physical scenes are modeled from inside and surfaces inside a building with all available details are visible to a user. The scan position may be indicated with a little green sphere or “bubbles” throughout the 3D point cloud and that's why it is sometime called a bubble view. In the present disclosure, the term “viewer-based perspective mode” may also be referred to as an interior view or a bubble view.

FIG. 2 illustrates an example of two different views of an outdoor scan for a telecom site. An outdoor scan may also be referred to as an exterior scan since an image scanning device is placed outside an object to be scanned. In this example a 3D point cloud is obtained by drone scanning outside the telecommunicate site. FIG. 2a illustrates an object-centered perspective mode of a 3D point cloud. FIG. 2b illustrates a viewer-based perspective mode of the same 3D point cloud. Since physical scenes are modeled from outside, FIG. 2a is a suitable view of the 3D point cloud. For this particular scan, a viewer-based perspective mode as shown in FIG. 2b will reveal mainly empty spaces and noises, as a drone camera will not be able to capture surfaces inside the telecommunication site.

When a point cloud viewer opens a 3D point cloud in PLY or LAS format, it does not know which view to use and switches by default to object-centered perspective mode. If the 3D point cloud is produced by an indoor scan (as the example shown in FIG. 1), it is impossible for the user to get any useful information and perform measurements by object-centered perspective mode. Some point cloud viewers allow for manual input, so if the user can guess a position of a camera inside a scanned space, the user may manually change the view. Such position however is very difficult to guess. Therefore, except the rare cases when formats like E57 are used which contain camera poses as additional metadata, in many case the original metadata from the scanning step is missing and the user has no means to inspect a 3D point cloud with a suitable view automatically.

### SUMMARY

An object of the present disclosure is to provide a method, a computing device, a computer program, a computer program product and a carrier which seek to mitigate, alleviate, or eliminate one or more of the above-identified deficiencies in the art and disadvantages singly or in any combination.

According to a first aspect of the invention there is presented a method for determining a view of a 3D point cloud for display on a 2D screen. The method is performed by a computing device. The method comprises obtaining the 3D point cloud. If a normal vector is available for each point of the 3D point cloud, the method comprises determining the view based on directions of normal vectors for points of the 3D point cloud. Otherwise the method comprises estimating a normal vector for each point of the 3D point cloud, and determining the view based on estimated normal vectors with symmetrical directions for points of the 3D point cloud.

According to a second aspect of the invention there is presented a computing device for determining a view of a 3D point cloud for display on a 2D screen. The computing device comprises a processing circuitry causing the computing device to be operative to obtain the 3D point cloud. If a normal vector is available for each point of the 3D point cloud, the processing circuitry causes the computing device to be operative to determine the view based on directions of normal vectors for points of the 3D point cloud. Otherwise the processing circuitry causes the computing device to be operative to estimate a normal vector for each point of the 3D point cloud, and to determine the view based on estimated normal vectors with symmetrical directions for points of the 3D point cloud.

According to a third aspect of the invention there is presented a computer program comprising instructions which, when executed on a processing circuitry, cause the processing circuitry to perform the method of the first aspect.

According to a fourth aspect of the invention there is presented a computer program product comprising a computer readable storage medium on which a computer program according to the third aspect, is stored.

According to a fifth aspect of the invention there is a carrier containing the computer program according to the third aspect, wherein the carrier is one of an electronic signal, an optical signal, a radio signal, and a computer readable storage medium. Advantageously, these aspects provide a way of automatic view selection for point cloud viewers (i.e., point cloud rendering tools). Advantageously, these aspects provide improved visualization of 3D point clouds as rendered on a 2D screen. Advantageously, these aspects facilitate automatic navigation in a 3D point cloud.

Other objectives, features and advantages of the enclosed embodiments will be apparent from the following detailed disclosure, from the attached dependent claims as well as from the drawings.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 illustrates an example of different views of a 3D point cloud for an office building;

FIG. 2 illustrates an example of different views of a 3D point cloud for a telecommunication site;

FIG. 3 illustrates examples of an interior scan and an exterior scan;

FIG. 4 is a flowchart illustrating operations of a computing device in accordance with some embodiments of the present disclosure;

FIG. 5 is a schematic diagram illustrating an angle φ in accordance with some embodiments of the present disclosure; and

FIG. 6 is a block diagram of a computing device in accordance with some embodiments of the present disclosure.

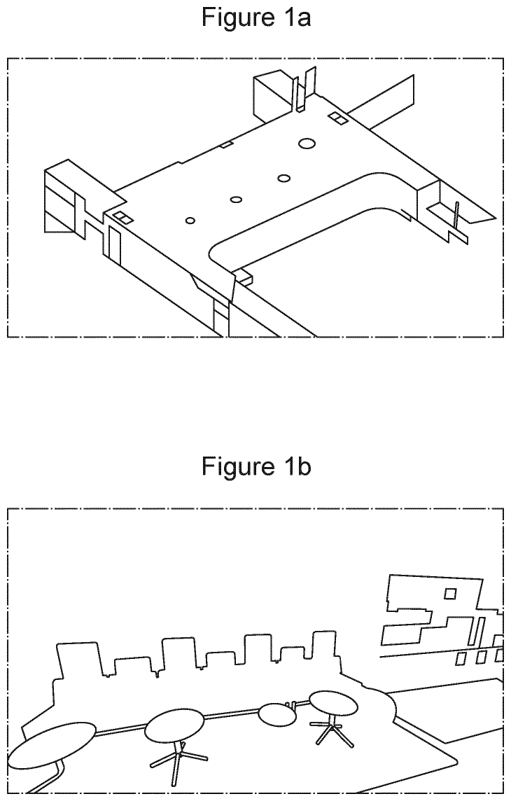

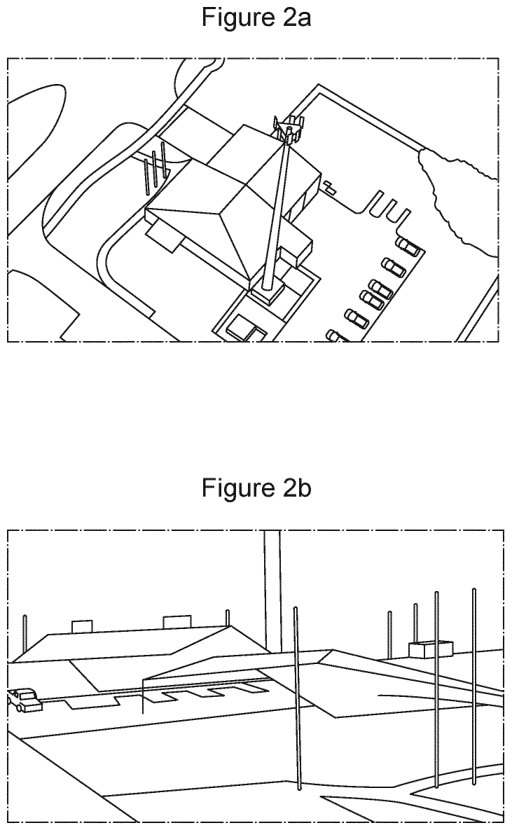

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description of the figures.

The terminology used herein is for the purpose of describing particular aspects of the disclosure only, and is not intended to limit the invention. As used herein, the singular forms “a”, “an” and “the” are intended to include the plural forms as well, unless the context clearly indicates otherwise.

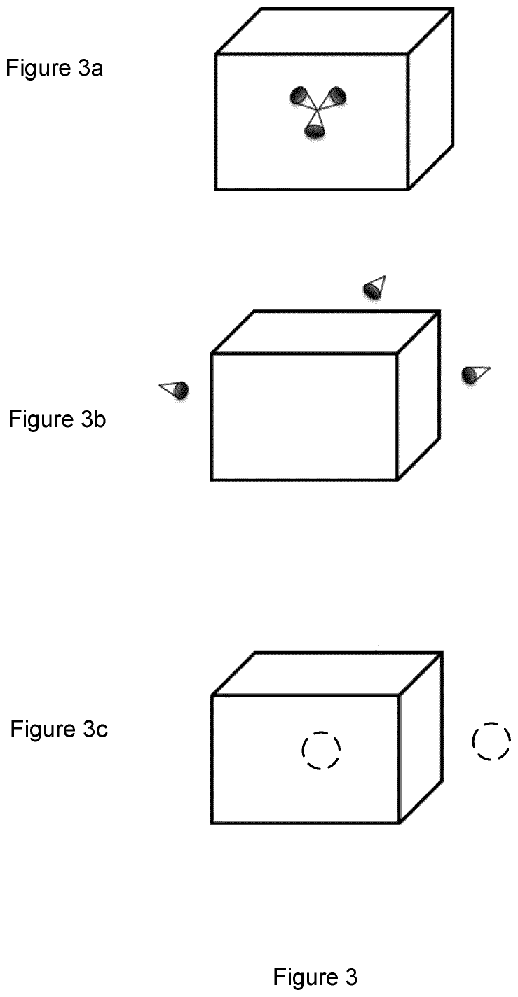

FIG. 3 illustrates examples of an interior scan and an exterior scan, where a cube represents an object to be scanned. FIG. 3a shows an interior scan example. It can be seen that an image scanning device(s) is within the cube and has different poses (i.e., position and attitude of the image scanning device). Multiple scans may be performed to obtain information of all sides of an interior environment. The term “interior scan” means that an image scanning device is placed within a scanned object. For an interior scan, an interior view is suitable to show interior details of the scanned object. FIG. 3b shows an example of an exterior scan, where an image scanning device(s) is placed outside the cube and has different poses. The term “exterior scan” means that an image scanning device is placed outside a scanned project. For an exterior scan, an exterior view is suitable which shows an exterior environment of the scanned object. FIG. 3c illustrates a technical application of the present disclosure. In FIG. 3c, there is one circle shown in dashed line within the cube representing an interior view, and one circle shown in dashed line outside the cube representing an exterior view. A view may be referred to as a viewport representing a visible area on a screen. Given only a 3D point cloud for an object (as shown as a cube), it is determined automatically if an interior view or an exterior view is suitable for displaying the 3D point cloud on a 2D screen.

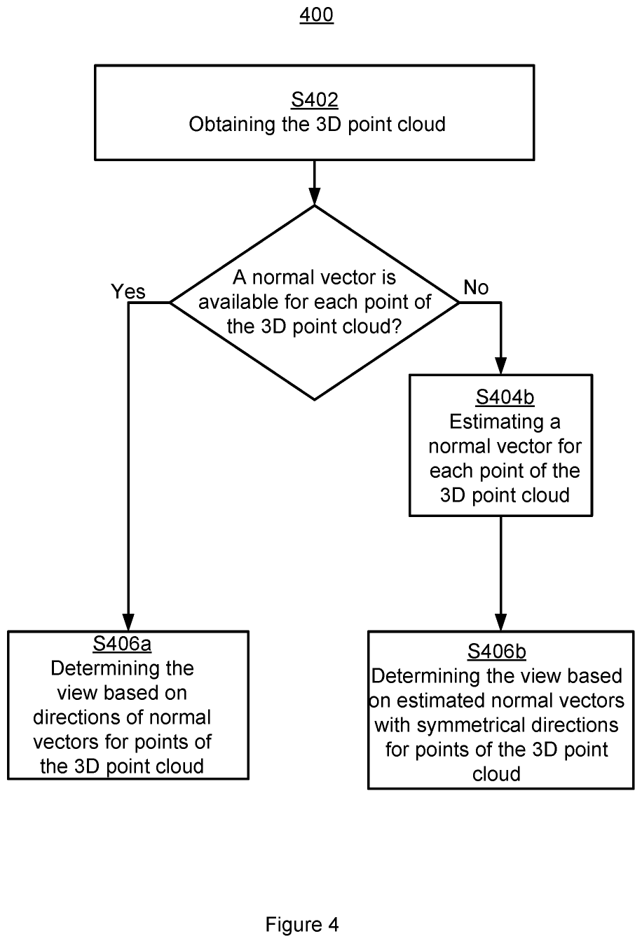

FIG. 4 is a flowchart illustrating a method 400 performed by a computing device for determining a view of a 3D point cloud for display on a 2D screen according to some embodiments described herein. Referring to FIG. 4, in a first step S402, the method comprises obtaining the 3D point cloud. If a normal vector is available for each point of the 3D point cloud, in step S406a, the method comprises determining the view based on directions of normal vectors for points of the 3D point cloud. Otherwise, in step S404b, the method comprises estimating a normal vector for each point of the 3D point cloud. In step S406b, the method comprises determining the view based on estimated normal vectors with symmetrical directions for points of the 3D point cloud. The method may advantageously be provided as a computer program.

The method 400 may be integrated into available point cloud viewer tools, such as CloudCompare and Potree. The method 400 may be implemented as a plug-in function. The method 400 may be executed after a point cloud is loaded, but before it is visualized to the user, so that a suitable view is determined automatically for display.

The obtained 3D point cloud may include X, Y, and Z coordinates of a collection of points representing surfaces of one or more objects. The obtained 3D point cloud may include additional attributes associated with the collection of points, such as color, intensity, normal vectors, and thermic information.

The 3D point cloud may be acquired by different types of image scanning devices such as 3D scanners, stereo cameras, and LiDAR (Light Detection and Ranging) systems (i.e., a combination of 3D scanning and laser scanning). For an interior scan, the 3D point cloud may be acquired by a hand-held computing device (e.g., a tablet computer, a laptop computer, and a smartphone) or a stationary scanning equipment. For an exterior scan, the 3D point cloud may be acquired by an Unmanned Aerial Vehicle (UAV) equipped with at least a camera.

The obtained 3D point cloud may already be decoupled from a data acquisition process (i.e., the point cloud doesn't carry any information from the data acquisition process), so no information is available about the type of scan, camera poses, etc. This decoupling typically happens due to additional point cloud operations, e.g., fusion, denoising, compression, etc. As an example, if an end user is using compressed points, for example using Video-based Point Cloud Compression (V-PCC) standard or Geometry based Point Cloud Compression specification (G-PCC) standard, the obtained 3D point cloud will be in Polygon File Format (PLY) format, which is already decoupled from camera poses and there is no information that can be used directly for determining the view for rendering the obtained 3D point cloud. As another example, the obtained 3D point cloud may be a fused point cloud in e.g., LAS format where no camera poses are available.

The obtained 3D point cloud may have a normal vector for each point, that is, for a point m, a normal vector (Nₘ^{X}, Nₘ^{Y}, Nₘ^{Z}) is available. A normal vector may be referred to as a normal or a surface normal. In the present context, a normal vector may have magnitude 1 and be referred to as a unit normal vector.

In some embodiments, the method 400 comprises obtaining a center point (X_{c}, Y_{c}, Z_{c}) of the 3D point cloud. The center point may already be available or it can be calculated. Each coordinate of the center point may be a mean of the corresponding coordinates of the points in the 3D point cloud. For example, for a 3D point cloud with M points, the center point may be calculated as

$${X}_{c} = \frac{1}{M} {\sum }_{m = 1}^{M} {X}_{m} , {Y}_{c} = \frac{1}{M} {\sum }_{m = 1}^{M} {Y}_{m} , and {Z}_{c} = \frac{1}{M} {\sum }_{m = 1}^{M} {Z}_{m} .$$

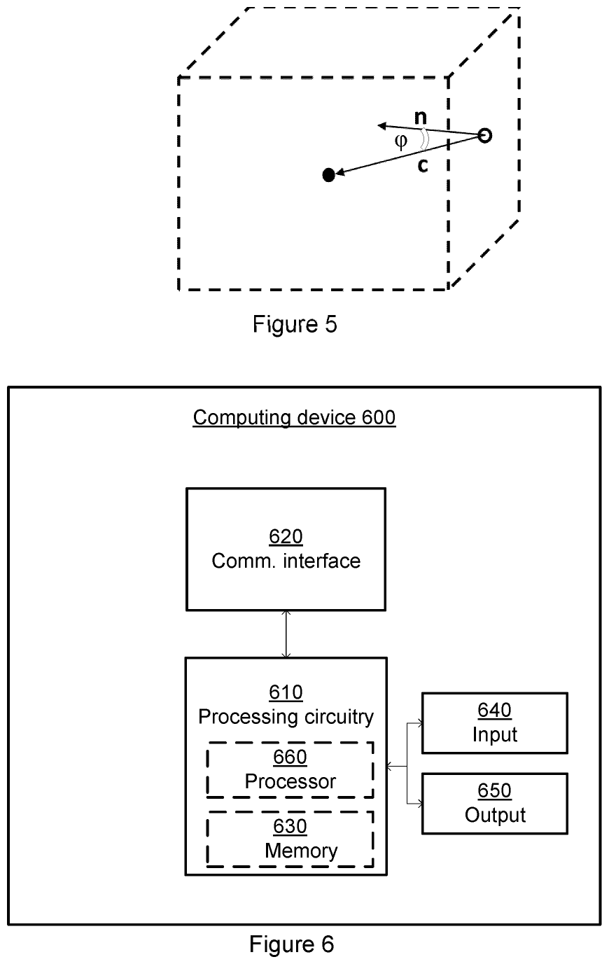

For a point of the 3D point cloud, the method 400 may comprise calculating an angle φ between the point's normal vector n and a vector c pointing to the center point of the 3D point cloud from the point. As it is shown in FIG. 5, the center point of the point cloud is illustrated as a black solid circle associated with coordinates (X_{c}, Y_{c}, Z_{c}). The point m on a surface of a cubic object is illustrated as a circle with black outline associated with coordinates (Xₘ, Yₘ, Zₘ). The angle φ is illustrated as the angle between the normal vector n and the vector c. The angle φ may be calculated by

$$φ = {cos}^{- 1} ( \frac{n \cdot c}{\vert n \vert \vert c \vert} ) .$$

In some embodiments, determining the view based on the angle φ further comprises determining a number N of points of the 3D point cloud having an angle φ less than 90 degree. The number N of points represents the number of points with normal vectors pointing towards the center point of the point cloud. The method 400 may comprise comparing a ratio of N to M, N/M, with a first threshold value Θ₁, where M is a number of points of the 3D point cloud. In some embodiments, M is a total number of points of the 3D point cloud.

The method 400 may comprise determining an interior view for the 3D point cloud if N/M≥Θ₁. The method 400 may comprise determining an exterior view for the 3D point cloud if N/M<Θ₁. If the ratio N/M is greater (or equal) to the first threshold value Θ₁, it indicates that a great percentage of normal vectors points towards the center point of the point cloud, which further indicates that an image scanning device (e.g., a smartphone) is inside a scanned object and an interior view is suitable for display. On the contrary, if the ratio N/M is less than the first threshold value Θ₁, it indicates that a great percentage of normal vectors points in direction opposite to the center point of the point cloud, which further indicates that an image scanning device (e.g., a drone equipped with a camera) is placed outside a scanned object and an exterior view is suitable for display.

In the present context, an interior view indicates an image scanning device being placed inside a scanned object. An exterior view indicates an image scanning device being placed outside a scanned object. Based on orientation of an image scanning device, an interior view may be referred to as an inside-out view and an exterior view may be referred to as an outside-in view. Based on indoor or outdoor environment, an interior view may be referred to as an indoor view and an exterior view may be referred to as an outdoor view. In some point cloud viewers, an interior view may be considered as a viewer-based perspective mode, and it may be named as a bubble view that represents a location where an image scanning device was placed (i.e., a scan position) during a point cloud creation. An exterior view may be considered as an object-centered perspective mode.

In some embodiments, determining the view based on the angle φ comprises sub-sampling the 3D point cloud and obtain a sub-sampled 3D point cloud. The method comprises determining a number N′ of points of the sub-sampled 3D point cloud having an angle φ less than 90 degree. The method comprises comparing a ratio of N′ to M′, N′/M′, with a first threshold value Θ₁, where M′ is a number of points of the sub-sampled 3D point cloud. The method further comprises determining an interior view for the 3D point cloud if N′/M′≥Θ₁; and determining an exterior view for the 3D point cloud if N′/M′<Θ₁. For a 3D point cloud with a great number of points, to sub-sample the 3D point cloud can reduce the computation complexity of calculating the angle φ for each point.

In some embodiments, sub-sampling a 3D point cloud may be performed by a voxelGrid filter, spatial sub-sampling where a user sets a minimal distance between two points, and the like. In the present context, terms “sample” or “down-sample” may be used instead of “sub-sample”.

In some embodiments, sub-sampling the 3D point cloud comprises randomly sub-sampling the 3D point cloud, where a specified number of points is selected in a random manner. It may be implemented as randomly removing entries from a list of all 3D points and it is time efficient.

In some embodiments, the first threshold value Θ₁ may have a value of 0.95. The value 0.95 allows for 5% of the normal vectors to point in direction opposite to the center point of the point cloud, in other words, a direction that doesn't face a center point of a scanned object but points outwards. The first threshold value may be obtained based on empirically observation. The first threshold value may also be obtained based on statistical methods or machine learning methods.

In some embodiments, if a normal vector is not available for each point of the 3D point cloud, a normal vector for a point of the 3D point cloud is estimated based on fitting a plane on a set of neighboring points to the point at which the normal vector is to be estimated. One possible way to estimate a normal vector is described by Hugues Hoppe, Tony DeRose, Tom Duchamp, John McDonald, Werner Stuetzle, “Surface reconstruction from unorganized points”, SIGGRAPH '92, Proceedings of the 19th annual conference on Computer graphics and interactive techniques, July 1992, Pages 71-78, https://doi.org/10.1145/133994.134011. This method can be described as following:

Input is an unorganized collection of 3D points \vec{X}ₘ=(Xₘ, Yₘ, Zₘ), m=1 . . . M.

For m=1 . . . M:
Select k closest neighboring points of \vec{x}ₘ (typically k=6)
Fit a local plane (least squares best fitting of k neighbors). This is used as a local linear approximation to the surface around the \vec{x}ₘ.
Calculate covariance matrix R_{3×3}. Using principal component analysis determine the 3 eigenvalues {λ₁, λ₂, λ₃}, and 3 eigenvectors {\vec{v}₁, \vec{v}₂, \vec{v}₃}.
The eigenvector associate with smallest eigenvalue (this one should be orthogonal to the plane) is selected as the normal \hat{n}ₘ=\vec{v}₃

Output is a set of normal vectors associated with the 3D points \hat{\vec{n}}m=(Nₘ^{x}, Nₘ^{y}, Nₘ^{z}), m=1 . . . M.

The estimated normal vectors \hat{n} are relative to each other, but there is a randomness in assigning directions of the normal vectors of the initial plane. Assuming neighboring planes are oriented in a similar way (i.e., neighboring points have similar normal vectors with same sign), a rule is to pick an initial plane and from there to orient the normal vectors of the neighboring planes. As a result, based on the chosen sign of the initial plane, the estimated normal vectors either have correction directions, or flipped directions (i.e., have a wrong sign). Therefore, the directions of the estimated normal vectors may be wrong, but symmetries of the 3D point cloud are kept correct.

In some embodiments, determining the view based on estimated normal vectors with symmetrical directions for points of the 3D point cloud comprises computing a sum of the estimated normal vectors Σₙ₌₁ \hat{n}ₘ, m=1 . . . M, where \hat{n}ₘ is an estimated normal vector for point m, and M is a number of points of the 3D point cloud. In some embodiments, M is a total number of points of the 3D point cloud.

For an interior/indoor scan, due to for example opposite walls and floor-ceiling symmetry, a 3D point cloud can be created with symmetries. Although it is very difficult to get absolute symmetry by an interior/indoor scan due to geometry of a room or presence of surfaces from which a laser beam of a LiDAR system does not reflect, etc., an interior/indoor scan will result in more normal vectors with symmetric directions than an exterior/outdoor scan. In the present context, symmetric direction may also be referred to as symmetric orientation. As referred to herein, the term “estimated normal vectors with symmetrical directions” includes, without limitation, estimated normal vectors with 1800 rotational symmetry around the center of a 3D point cloud. Therefore, a selection between an interior view (e.g., based on an interior scan) or an exterior view (e.g., based on an exterior scan) may be determined based on if the estimated normal vectors have symmetrical directions or not.

In some embodiments, determining the view based on estimated normal vectors with symmetrical directions for points of the 3D point cloud comprises comparing a ratio of a norm of the sum of the estimated normal vectors to the number of points of the 3D point cloud, ∥Σₙ₌₁^{M} \hat{n}ₘ∥/M, m=1 . . . M, with a second threshold value Θ₂. The method comprises determining an interior view for the 3D point cloud if ∥Σₙ₌₁^{M} \hat{n}ₘ∥/M≤Θ₂. The method comprises determining an exterior view for the 3D point cloud if ∥Σₙ₌₁^{M} \hat{n}ₘ∥/M>Θ₂. In some embodiments, the second threshold value Θ₂ may have a value of 0.15. The second threshold value may be obtained based on empirically observation. The second threshold value may also be obtained based on statistical methods or machine learning methods.

For an interior scan and a totally symmetric environment, the norm of the sum of the estimated normal vectors will be zero as the normal vectors cancel each other due to symmetry. However, in a realistic scenario it is expected that up to 15% of the normal vectors are not cancelled and this is captured by the second threshold value Θ₂. For an outdoor/exterior scan, for example in a scenario that a drone is scanning a house, the floor of the house is completely occluded. This leads to that in the resulting 3D point cloud, there will be no points representing the floor. Therefore, even if there are complete cancellations of the normal vectors from the opposite walls, there is nothing to cancel the normal vectors from the roof, which may typically result in that more than 15% of the normal vectors are not cancelled.

In some embodiments, there is a user interface (UI) button. The determined view of a three-dimensional 3D point cloud may be used as a recommendation to a user and the user may press the UI button to actively select the view for display on a 2D screen. In this way, the present disclosure may be combined with a UI button to select a view.

FIG. 6 schematically illustrates, in terms of functional units, the components of a computing device 600 according to an embodiment. The computing device may be a user interface device for display and interaction with a user. The computing device may be various forms of digital computers, image processing devices and similar type of devices, such as digital TV sets, set-top boxes and receivers (e.g., cable, terrestrial, Internet Protocol television (IPTV), etc.), laptops, desktops, workstations, personal digital assistants, mobile devices such as smartphone, mobile phone, mobile tablets, and other appropriate computers. Processing circuitry 610 is provided using any combination of one or more of a suitable central processing unit (CPU), multiprocessor, microcontroller, digital signal processor (DSP), etc. The processing circuitry 610 may comprise a processor 660 and a memory 630 wherein the memory 630 contains instructions executable by the processor 660. The memory 630 may further contain a computer program product. The processing circuitry 610 may further be provided as at least one application specific integrated circuit (ASIC), or field programmable gate array (FPGA). The computing device may comprise input 640 and output 650. The input 640 may comprise a touch panel, a keyboard, and the like. The output 550 may comprise a display screen configured to display a 2D view of a 3D point cloud.

The computing device 600 may further comprise a communication interface 620. The communication interface 620 may implement one or more of various wireless technologies, such as Wi-Fi, Bluetooth, Zigbee, and so on. A wired network interface, e.g., Ethernet (not shown in FIG. 6) may further be provided as part of the computing device 600 to facilitate a wired connection to a network.

Particularly, the processing circuitry 610 is configured to cause the computing device 600 to perform a set of operations, or steps, as disclosed above. For example, the memory 630 may store instructions which implement the set of operations, and the processing circuitry 610 may be configured to retrieve the instructions from the memory 630 to cause the computing device 600 to perform the set of operations as herein disclosed. The memory 630 may also comprise persistent storage, which, for example, can be any single one or combination of magnetic memory, optical memory, solid state memory or even remotely mounted memory.

In some embodiments, a computer program comprises instructions which, when executed on the processing circuitry 610, cause the processing circuitry 610 to perform methods as herein disclosed. The computer program may be downloaded to the memory 630 by means of the communication interface 620.

In some embodiments, a computer program product comprises a computer readable storage medium on which a computer program as herein disclosed is stored. The computer program and/or computer program product may thus provide means for performing any steps as herein disclosed. The computer program product may be an optical disc, such as a CD (compact disc) or a DVD (digital versatile disc) or a Blu-Ray disc. The computer program product could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, the computer program may be stored in any way which is suitable for the computer program product.

In some embodiments, a carrier may contain a computer program as herein disclosed, wherein the carrier is one of an electronic signal, an optical signal, a radio signal, and a computer readable storage medium.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for determining a view of a three-dimensional, 3D, point cloud for display on a two-dimensional, 2D, screen, the method performed by a computing device and comprising:
obtaining the 3D point cloud;
if a normal vector is available for each point of the 3D point cloud, determining the view based on directions of normal vectors for points of the 3D point cloud;
otherwise estimating a normal vector for each point of the 3D point cloud; and
determining the view based on estimated normal vectors with symmetrical directions for points of the 3D point cloud.

2. The method of claim 1, wherein the determining the view based on directions of normal vectors for points of the 3D point cloud further comprises:
obtaining a center point of the 3D point cloud;
for a point of the 3D point cloud, calculating an angle φ between the point's normal vector n and a vector c pointing to the center point of the 3D point cloud from the point; and
determining the view based on the angle φ.

3. The method of claim 2, wherein the angle φ is calculated by
$$φ = {cos}^{- 1} ( \frac{n \cdot c}{\vert n \vert \vert c \vert} ) .$$

4. The method of claim 2, wherein the determining the view based on the angle φ further comprises:
determining a number N of points of the 3D point cloud having an angle φ less than 90 degree;
comparing N/M with a first threshold value Θ₁, where M is a number of points of the 3D point cloud;
determining an interior view for the 3D point cloud if N/M≥Θ₁; and
determining an exterior view for the 3D point cloud if N/M<Θ₁.

5. The method of claim 2, wherein the determining the view based on the angle φ further comprises:
sub-sampling the 3D point cloud;
obtaining a sub-sampled 3D point cloud;
determining a number N′ of points of the sub-sampled 3D point cloud having an angle φ less than 90 degree;
comparing N′/M′ with a first threshold value Θ₁, where M′ is a number of points of the sub-sampled 3D point cloud;
determining an interior view for the 3D point cloud if N′/M′≥Θ₁; and
determining an exterior view for the 3D point cloud if N′/M′<Θ₁.

6. The method of claim 5, wherein the sub-sampling the 3D point cloud comprises randomly sub-sampling the 3D point cloud.

7. The method of claim 1, wherein the determining the view based on estimated normal vectors with symmetrical directions for points of the 3D point cloud comprises computing a sum of estimated normal vectors Σₘ₌₁^{M} \hat{n}ₘ, where \hat{n}ₘ is an estimated normal vector for point m, and M is a number of points of the 3D point cloud.

8. The method of claim 7, wherein the determining the view based on estimated normal vectors with symmetrical directions for points of the 3D point cloud further comprises:
comparing a ratio of a norm of the sum of the estimated normal vectors to the number of points of the 3D point cloud, ∥Σₙ₌₁^{M} \hat{n}ₘ∥/M, with a second threshold value Θ₂;
determining an interior view for the 3D point cloud if ∥Σₙ₌₁^{M} \hat{n}ₘ∥/M≤Θ₂; and
determining an exterior view for the 3D point cloud if ∥Σₙ₌₁^{M} \hat{n}ₘ∥/M≥Θ₂.

9. A computing device for determining a view of a three-dimensional, 3D, point cloud for display on a two-dimensional, 2D, screen, the computing device comprising a processing circuitry causing the computing device to be operative to:
obtain the 3D point cloud;
if a normal vector is available for each point of the 3D point cloud, determine the view based on directions of normal vectors for points of the 3D point cloud;
otherwise estimate a normal vector for each point of the 3D point cloud; and determine the view based on estimated normal vectors with symmetrical directions for points of the 3D point cloud.

10. The computing device of claim 9, wherein to determine the view based on directions of normal vectors for points of the 3D point cloud further comprises to:
obtain a center point of the 3D point cloud;
for a point of the 3D point cloud, calculate an angle φ between the point's normal vector n and a vector c pointing to the center point of the 3D point cloud from the point; and
determine the view based on the angle φ.

11. The computing device of claim 10, wherein the angle Y is calculated by
$$φ = {cos}^{- 1} ( \frac{n \cdot c}{\vert n \vert \vert c \vert} ) .$$

12. The computing device of claim 10, wherein to determine the view based on the angle φ further comprises to:
determine a number N of points of the 3D point cloud having an angle φ less than 90 degree;
compare N/M with a first threshold value Θ₁, where M is a number of points of the 3D point cloud;
determine an interior view for the 3D point cloud if N/M≥Θ₁; and
determine an exterior view for the 3D point cloud if N/M<Θ₁

13. The computing device of claim 10, wherein to determine the view based on the angle φ further comprises to:
sub-sample the 3D point cloud;
obtain a sub-sampled 3D point cloud;
determine a number N′ of points of the sub-sampled 3D point cloud having an angle φ less than 90 degree;
compare N′/M′ with a first threshold value Θ₁, where M′ is a number of points of the sub-sampled 3D point cloud;
determine an interior view for the 3D point cloud if N′/M′≥Θ₁; and
determine an exterior view for the 3D point cloud if N′/M′<Θ₁.

14. The computing device of claim 13, wherein to sub-sample the 3D point cloud comprises to randomly sub-sample the 3D point cloud.

15. The computing device of claim 9, wherein to determine the view based on estimated normal vectors with symmetrical directions for points of the 3D point cloud comprises to compute a sum of estimated normal vectors Σₘ₌₁^{N} \hat{n}ₘ, where \hat{n}ₘ is an estimated normal vector for point m, and M is a number of points of the 3D point cloud.

16. The computing device of claim 15, wherein to determine the view based on estimated normal vectors with symmetrical directions further comprises to:
compare a ratio of a norm of the sum of the estimated normal vectors to the number of points of the 3D point cloud, ∥Σₙ₌₁^{M} \hat{n}ₘ∥/M, with a second threshold value Θ₂;
determine an interior view for the 3D point cloud if ∥Σₙ₌₁^{M} \hat{n}ₘ∥/M≤Θ₂; and
determine an exterior view for the 3D point cloud if ∥Σₙ₌₁^{M} \hat{n}ₘ∥/M≥Θ₂.

17. (canceled)

18. A computer program product comprising a non-transitory computer readable medium to be executed by processing circuitry of a computing device configured to determine a view of a three-dimensional, 3D, point cloud for display on a two-dimensional, 2D, screen, whereby execution of the computer program code cause the computer program code to perform operations comprising:
obtain the 3D point cloud;
if a normal vector is available for each point of the 3D point cloud, determine the view based on directions of normal vectors for points of the 3D point cloud;
otherwise estimate a normal vector for each point of the 3D point cloud; and
determine the view based on estimated normal vectors with symmetrical directions for points of the 3D point cloud.

19. A carrier containing the computer program of claim 18, wherein the carrier is one of an electronic signal, an optical signal, a radio signal, and a computer readable storage medium.

20. A non-transitory computer readable medium including program code to be executed by processing circuitry of a computing device configured to determine a view of a three-dimensional, 3D, point cloud for display on a two-dimensional, 2D, screen, whereby execution of the program code causes the program code to perform operations comprising:
obtain the 3D point cloud;
if a normal vector is available for each point of the 3D point cloud, determine the view based on directions of normal vectors for points of the 3D point cloud;
otherwise estimate a normal vector for each point of the 3D point cloud; and
determine the view based on estimated normal vectors with symmetrical directions for points of the 3D point cloud.

21. The non-transitory computer readable medium of claim 20, wherein determine the view based on directions of normal vectors for points of the 3D point cloud further comprises:
obtain a center point of the 3D point cloud;
for a point of the 3D point cloud, calculate an angle φ between the point's normal vector n and a vector c pointing to the center point of the 3D point cloud from the point; and
determine the view based on the angle φ.
